(19) United States
(12) Patent Application Publication
(10) Pub. No.: US 2025/0377963 A1
(43) Pub. Date: Dec. 11, 2025

(54) UNCORRECTABLE ERROR DETECTION IN MEMORY SYSTEMS

(71) Applicant: Micron Technology, Inc., Boise, ID (US)

(72) Inventor: Scott E. Schaefer, Boise, ID (US)

(21) Appl. No.: 19/221,307

(22) Filed: May 28, 2025

Related U.S. Application Data
(60) Provisional application No. 63/657,019, filed on Jun. 6, 2024.

(51) Int. Cl. G06F 11/07

(52) U.S. Cl. CPC G06F 11/0772; G06F 11/073; G06F 11/0793

(57) ABSTRACT

Methods, systems, and devices for uncorrectable error detection in memory systems are described. A memory system may perform a syndrome check to compare a first syndrome with a second syndrome, the first syndrome being generated as part of a first error control operation performed on data and the second syndrome being generated as part of a second error control operation performed on the data. Based on performing the syndrome check, the memory system may generate a first flag that indicates whether the first syndrome is equivalent to the second syndrome. The memory system may generate a second flag that indicates whether the second error control operation resulted in one or more bits of the data being modified. Based on the first and second flags, the memory system may generate a third flag that indicates whether an uncorrectable error is detected in the data during the second error control operation.

### CROSS REFERENCE

The present Application for Patent claims priority to U.S. Patent Application No. 63/657,019 by Schaefer, entitled “UNCORRECTABLE ERROR DETECTION IN MEMORY SYSTEMS,” filed Jun. 6, 2024, which is assigned to the assignee hereof, and which is expressly incorporated by reference in its entirety herein.

### TECHNICAL FIELD

The following relates to one or more systems for memory, including uncorrectable error detection in memory systems.

### BACKGROUND

Memory devices are used to store information from devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports uncorrectable error detection in memory systems in accordance with examples as disclosed herein.

FIG. 2 shows an example of an error correction circuit that supports uncorrectable error detection in memory systems in accordance with examples as disclosed herein.

FIG. 3 shows an example of a syndrome check circuit that supports uncorrectable error detection in memory systems in accordance with examples as disclosed herein.

FIG. 4 shows an example of a bit modification and detection circuit that supports uncorrectable error detection in memory systems in accordance with examples as disclosed herein.

FIG. 5 shows a block diagram of a memory system that supports uncorrectable error detection in memory systems in accordance with examples as disclosed herein.

FIG. 6 shows a flowchart illustrating a method or methods that support uncorrectable error detection in memory systems in accordance with examples as disclosed herein.

### DETAILED DESCRIPTION

Some memory systems may be implemented in host systems, where such host systems may be associated with safety related applications. Accordingly, a host system may request that an alert message be sent from an associated memory system indicating when data, transmitted from the memory system, includes one or more uncorrected errors (e.g., an alert that the data is compromised or an alert that the data is not good), such that the host system may avoid using such data during the safety related application. In some cases, a memory system may implement an error correction and code (ECC) scheme to correct one or more errors that occur within data, which may enable the memory system to correct bit errors within data prior to transmission of the data to the host system or detect errors in data and alert the host system to such errors. However, using such ECC schemes, the memory systems may not account for all errors present in the data, which may prohibit the memory system from alerting the host system to the compromised data. For example, if an uncorrectable error (e.g., multiple bit errors) occurs in the data, the ECC scheme of the memory system may fail to detect such errors (e.g., due to aliasing), leading to compromised data being transmitted to the host system without a corresponding alert indicating that such data is compromised.

In accordance with the techniques described herein, the memory system may implement an ECC circuit that provides for uncorrectable error detection, which may enable the memory system to provide alerts to the host system in response to uncorrectable errors being detected in data. For example, the ECC circuit may include a syndrome check circuit, a bit modification and detection circuit, and an uncorrectable error detection circuit to detect uncorrectable errors in data. The syndrome check circuit may be configured to compare first syndrome bits, generated on data at a first time, with second syndrome bits that are generated on the data at a second time. By comparing the first syndrome bits and the second syndrome bits, the syndrome check circuit may determine whether at least a single-bit error occurred in the data (e.g., based on the syndrome bits being different) or that the data is error free (e.g., based on the syndrome bits matching) and output a first flag indicating whether the at least single-bit error has occurred in the data. The bit detection and modification circuit may be configured to output a second flag indicating whether one or more bits of the data are modified during the second error control operation. For example, the bit detection and modification circuit may utilize the syndrome bits to identify whether the at least single-bit error in the data has occurred, and, if so, generate an error code associated with the at least single-bit error, and output the error code to a bit flipping circuit. In this way, the bit detection and modification circuit may determine whether one or more bits of the data are modified (by the bit flipping circuit).

Accordingly, the uncorrectable error detection circuit may be configured to compare the first flag (e.g., output of the syndrome check circuit) and the second flag (e.g., output of the bit detection and modification circuit) to generate a third flag indicating whether an uncorrectable error has occurred in the data. For example, if the first flag indicates that at least a single-bit error has occurred and the second flag indicates that at least a single-bit of the data has been modified, the uncorrectable error detection circuit may indicate, via the third flag, that the data is good and an error correction in the data has occurred. Similarly, if the first flag indicates that no errors are detected in the data and the second flag indicates that no bits of the data were modified, the uncorrectable error detection circuit may indicate, via the third flag, that the data is good and that no errors occurred in the data. Alternatively, if the first flag indicates that at least a single-bit error has occurred and the second flag indicates that no bits of the data were modified during the error control operation, the uncorrectable error detection may indicate, via the third flag, that an uncorrectable error has occurred in the data. In response to generating the third flag indicating the uncorrectable error, the memory system may alert the host system that the data is compromised.

In addition to applicability in memory systems as described herein, techniques for uncorrectable error detection in memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by alerting a host system to data that includes multi-bit errors, which may improve user experience, decrease the use of flawed data by the host system, among other benefits.

Features of the disclosure are illustrated and described in the context of systems and architectures. Features of the disclosure are further illustrated and described in the context of an error correction circuit, a syndrome check circuit, a bit modification and detection circuit, and flowcharts.

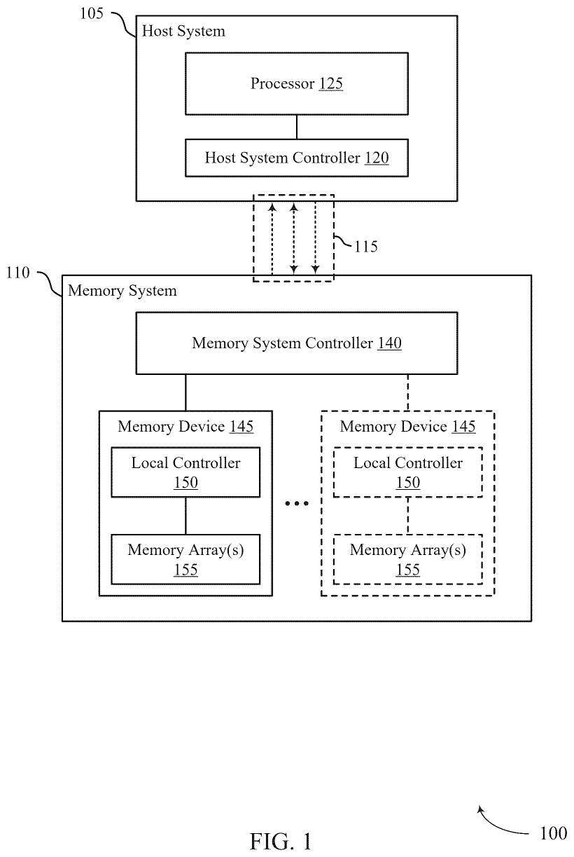

FIG. 1 illustrates an example of a system 100 that supports uncorrectable error detection in memory systems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some cases, the host system 105 be implemented as part of a safety related application, and, as such, may request that an alert message be sent from an associated memory system 110 indicating when data, transmitted from the memory system 110, includes one or more uncorrected errors (e.g., an alert that the data is compromised or an alert that the data is not good), such that the host system may avoid using such data during the safety related application. In some cases, a memory system 110 may implement an ECC scheme to correct one or more errors within data, which may enable the memory system 110 to correct bit errors within data prior to transmission of the data to the host system or detect errors in data and alert the host system to such errors. However, using such ECC schemes, the memory system 110 may not account for all errors present in the data, which may prohibit the memory system 110 from alerting the host system to the compromised data. For example, if an uncorrectable error (e.g., multiple bit errors) occurs in the data, the ECC scheme of the memory system 110 may fail to detect such errors (e.g., due to aliasing), leading to compromised data being transmitted to the host system 105 without a corresponding alert indicating that such data is compromised.

In accordance with the techniques described herein, the memory system 110 may implement an ECC circuit that provides for uncorrectable error detection, which may enable the memory system 110 to provide alerts to the host system 105 in response to uncorrectable errors being detected in data. For example, the ECC circuit may include a syndrome check circuit, a bit modification and detection circuit, and an uncorrectable error detection circuit to detect uncorrectable errors in data. The syndrome check circuit may be configured to compare first syndrome bits, generated on data at a first time, with second syndrome bits that are generated on the data at a second time. By comparing the first syndrome bits and the second syndrome bits, the syndrome check circuit may determine whether at least a single-bit error occurred in the data (e.g., based on the syndrome bits being different) or that the data is error free (e.g., based on the syndrome bits matching) and output a first flag indicating whether the at least single-bit error has occurred in the data. The bit detection and modification circuit may be configured to output a second flag indicating whether one or more bits of the data are modified during the second error control operation. For example, the bit detection and modification circuit may utilize the syndrome bits to identify whether at least a single-bit error in the data has occurred, and, if so, generate an error code associated with the error, and output the error code to a bit flipping circuit. In this way, the bit detection and modification circuit may determine whether one or more bits of the data are modified (by the bit flipping circuit).

Accordingly, the uncorrectable error detection circuit may be configured to compare the first flag (e.g., output of the syndrome check circuit) and the second flag (e.g., output of the bit detection and modification circuit) to generate a third flag indicating whether an uncorrectable error has occurred in the data. For example, if the first flag indicates that at least a single-bit error has occurred and the second flag indicates that a single-bit of the data has been modified, the uncorrectable error detection circuit may indicate, via the third flag, that the data is good and an error correction in the data has occurred. Similarly, if the first flag indicates that no errors are detected in the data and the second flag indicates that no bits of the data were modified, the uncorrectable error detection circuit may indicate, via the third flag, that the data is good and that no errors occurred in the data. Alternatively, if the first flag indicates that at least a single-bit error has occurred and the second flag indicates that no bits of the data were modified during the error control operation, the uncorrectable error detection may indicate, via the third flag, that an uncorrectable error has occurred in the data. In response to generating the third flag indicating the uncorrectable error, the memory system 110 may alert the host system 105 that the data is compromised.

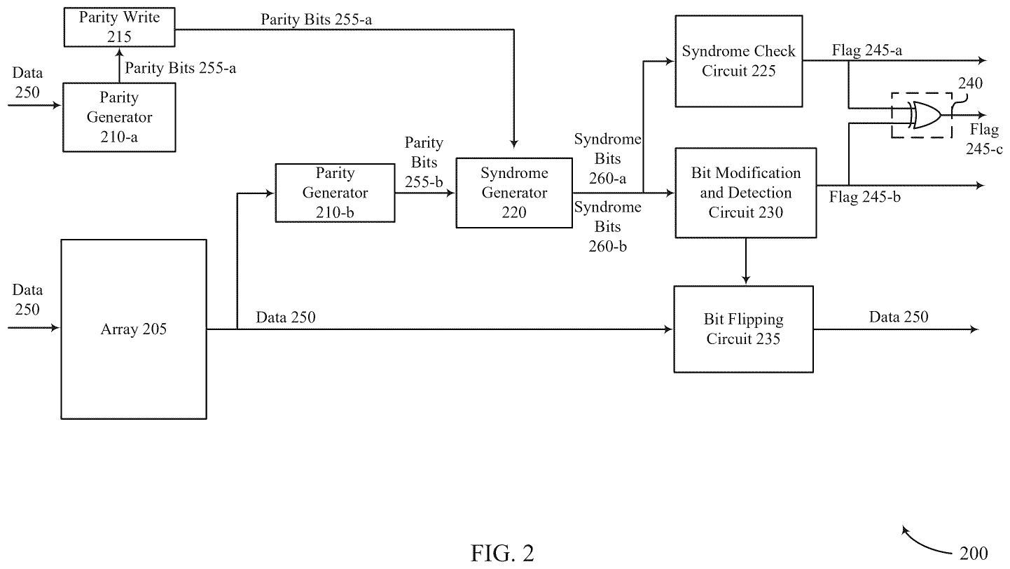

FIG. 2 shows an example of an error correction circuit 200 that supports uncorrectable error detection in memory systems in accordance with examples as disclosed herein. Aspects of the error correction circuit 200 may be implemented by the system 100, as described herein with reference to FIG. 1. For example, the error correction circuit 200 may be implemented by the memory system 110, the memory devices 145, or both. The error correction circuit 200 may include an array 205 (e.g., memory array 155) parity generators 210, a parity write 215, a syndrome generator 220, a syndrome check circuit 225, a bit modification and detection circuit 230, a bit flipping circuit 235, an uncorrectable error detection circuit 240, or any combination thereof. As described herein, the error correction circuit 200 may be implemented or performed for on-die ECC operations, in link ECC operations (e.g., write link ECC), or both. The techniques described in the context of the error correction circuit 200 may enable the error correction circuit 200 to identify whether uncorrectable errors (e.g., multiple bit errors) have occurred in data 250.

Some other ECC schemes (e.g., ECC engines) may provide error correction and data released by such ECC schemes may have a first diagnostic coverage. Diagnostic coverage may correspond to a measure of the effectiveness of the ECC scheme, where the diagnostic coverage may be defined as the ratio of a quantity of faults that can be detected to the quantity of possible faults occurring in the memory system. Accordingly, an ECC scheme having a high diagnostic coverage may indicate that such an ECC scheme is able to detect a relatively high quantity of errors, while an ECC scheme having a low diagnostic coverage may indicate that such an ECC scheme is not able to detect a relatively high quantity of errors.

In some cases, an ECC scheme may be produced to achieve a high diagnostic coverage and/or correct more than single-bit errors, however, such an ECC scheme may be implemented with an increased quantity of gates (e.g., take up more space on the memory system), come at an increased cost, or both. Due to such limitations, such other ECC schemes may be developed to achieve a reduced diagnostic coverage to reduce the quantity of gates at the memory system 110, to reduce cost of the memory system, or both. Accordingly, such other ECC schemes may transmit (e.g., pass on) data that has uncorrected errors. That is, because ECC schemes may be unable to achieve 100% diagnostic coverage (e.g., be unable to provide 100% correction or detection of all possible errors), the user of the data (e.g., a host system 105) that is released by the ECC scheme may assume some data will be compromised (e.g., have errors). For example, such other ECC schemes may be unable to identify whether uncorrectable bit errors (e.g., two or more bit errors) have occurred in the data 250 and pass on such compromised data 250 (e.g., data with uncorrectable errors) to the host system 105.

In some cases, the memory system 110, which may include such ECC schemes, may be implemented by a host system 105 that is operating within a safety related application. In such examples, the host system 105 may request that the memory system 110 provide an alert output indicating when data 250, transmitted by the memory system 110, is compromised (e.g., has errors). In such examples, however, if the ECC scheme of the memory system 110 is unable to detect if uncorrectable errors occur within the data 250, the memory system 110 may be unable to provide the alert output to the host system 105, thereby reducing the reliability of the safety related application.

In accordance with the techniques described herein, the error correction circuit 200 may provide the memory system 110 with a higher diagnostic capability by being able to detect whether uncorrectable errors occur in the data 250, while also maintaining a limited quantity of gates and reduced cost. By being able to detect such uncorrectable errors in the data 250, the memory system 110 may provide an alert output to the host system 105 indicating that such data 250 may be compromised. To do so, the error correction circuit 200 may generate and provide (e.g., transmit) data fault grading flags, such as a flag 245-a, a flag 245-b, and a flag 245-c, which may enable the error correction circuit 200 to correct errors and notify the host system 105 when the data 250 is compromised (e.g., has errors) and should not be used.

As described herein, an uncorrectable error may be any errors unable to be corrected by an ECC scheme. For example, if an ECC scheme is able to correct a single bit error within data 250, an uncorrectable error may be two or more bit errors within the data 250. Similarly, if the ECC scheme is able to correct up to two bit errors within the data 250, an uncorrectable error may be three or more bit errors within the data 250. Thus, if an ECC scheme is able to correct X bit errors within the data 250, an uncorrectable error may be X+1 or more bit errors within the data 250.

For example, the memory system 110 may write the data 250 to the array 205 (e.g., memory array 155). In response to, or concurrently with, writing the data 250 to the array 205, the memory system 110 may perform a first (e.g., initial) error control operation on the data 250. For example, the memory system 110 may input the data 250 into the parity generator 210-a, where the parity generator 210-a may generate parity bits 255-a (e.g., write parity bits, first parity bits, a first set of parity bits) based on the data 250 written to the array 205. In response to generating the parity bits 255-a, the parity generator 210-a may transmit the parity bits 255-a to the syndrome generator 220, where the syndrome generator 220 may generate syndrome bits 260-a (e.g., write syndrome bits, first syndrome bits, a first set of syndrome bits), where such syndrome bits 260-a may be stored along with the data 250 written to the array 205.

Accordingly, during a second error control operation (e.g., if the data 250 is being read from the array 205 at a later time or processed at a later time), the parity generator 210-b may obtain the data 250 read from the array 205 and generate the parity bits 255-b (e.g., read parity bits, second parity bits, a second set of parity bits) based on the data 250 read from the array 205. The syndrome generator 220 may obtain the parity bits 255-b and generate the syndrome bits 260-b (e.g., read syndrome bits, second syndrome bits, a second set of syndrome bits). The syndrome generator 220 may also obtain the syndrome bits 260-a from the array 205 in response to the data 250 being read. As such, the syndrome generator 220 may output both the syndrome bits 260-a and the syndrome bits 260-b to both the syndrome check circuit 225 and the bit modification and detection circuit 230.

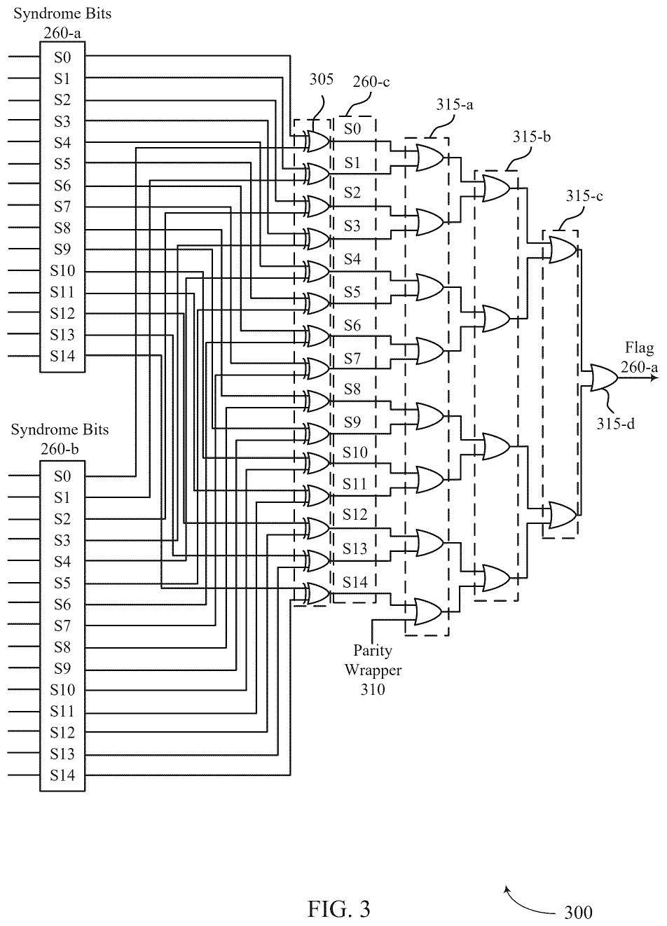

In such examples, the syndrome check circuit 225 may compare the syndrome bits 260-a (e.g., write syndrome bits or first syndrome bits) with the syndrome bits 260-b (e.g., read syndrome bits or second syndrome bits) to determine whether one or more errors have occurred in the data 250 during storage in the array 205 and output the flag 245-a, where a value (e.g., voltage) of the flag 245-a indicates whether the syndrome bits 260 match (e.g., whether errors occurred in the data 250). For example, if the syndrome bits 260-a match the syndrome bits 260-b (e.g., the syndrome bits are equal), the syndrome check circuit 225 may determine the data 250 is error-free. Accordingly, the syndrome check circuit 225 may generate and output the flag 245-a, where the value of the flag 245-a (e.g., ‘0’) indicates that the data 250 is error free and the syndrome bits 260 match. Alternatively, if the syndrome bits 260 do not match, the syndrome check circuit 225 determine that at least a single-bit error has (e.g., one or more bit errors have) occurred in the data 250 during the storage of the data 250. Accordingly, the syndrome check circuit 225 may generate and output the flag 245-a, where the value of the flag 245-a (e.g., ‘1’) indicates that the data 250 includes at least a single-bit error and the syndrome bits 260 do not match. The syndrome check circuit 225 and the techniques to compare the syndrome bits 260 may be further described herein with reference to FIG. 3.

The bit modification and detection circuit 230 may determine whether one or more bits of the data 250 read from the array 205 is modified by the bit flipping circuit 235 during the second error control operation and output the flag 245-b indicating whether the one or more bit errors in the data 250 are modified. For example, the bit modification and detection circuit 230 may compare the syndrome bits 260, where the output of the comparison (e.g., an exclusive OR (XOR) operation between each bit of the syndrome bits 260) generates one of multiple error codes. In such examples, a first subset of the error codes (e.g., valid error codes) may indicate that one or more errors have occurred in the data 250 and indicate the location of the one or more errors within the data 250 that are to be modified by the bit flipping circuit 235. A second subset of the error codes may indicate that no modification to the data 250 is to occur.

Accordingly, if the bit modification and detection circuit 230 determines that one or more bits have been flipped in the data (e.g., based on an error code indicating the one or more bit errors in the data 250), the bit modification and detection circuit 230 may output the error code to bit flipping circuit 235, where the bit flipping circuit 235 may utilize the error code to identify the location of the one or more bit errors within the data 250 and correct the corresponding errors. Additionally, in response to determining that the one or more bit errors in the data 250 have occurred, the bit modification and detection circuit 230 may generate and output the flag 245-b, where the value of the flag 245-b (e.g., a ‘1’) indicates that a one or more bits of the data 250 have been modified.

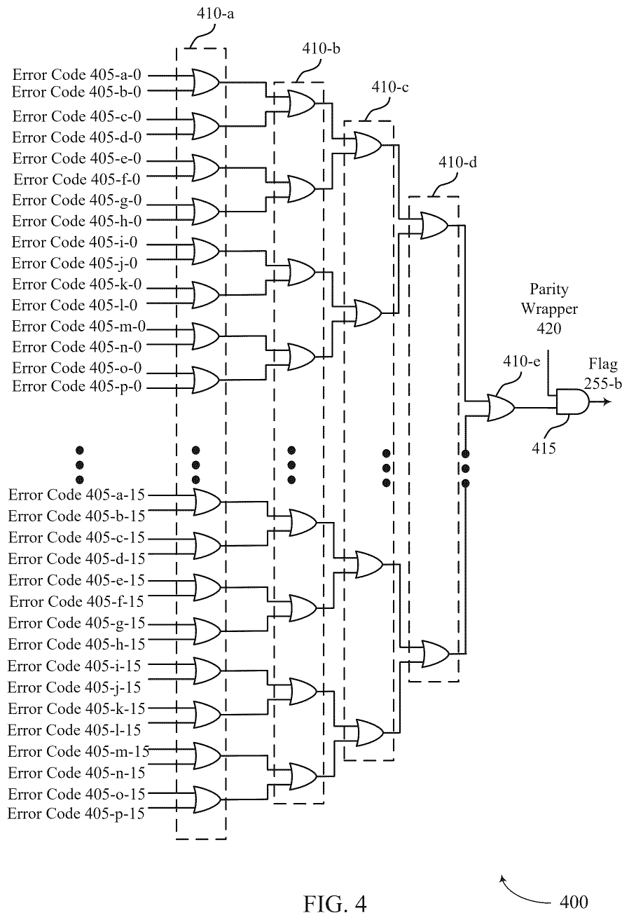

Alternatively, if the bit modification and detection circuit 230 determines an error code indicating that the data 250 is not to be modified, the bit modification and detection circuit 230 may generate and output the flag 245-b, where the value of the flag 245-b (e.g., ‘0’) indicates that the data 250 has not been modified. In some cases, the bit modification and detection circuit 230 may indicate the error code to the bit flipping circuit 235, where the bit flipping circuit 235 may refrain from modifying the data 250. In some cases, the bit modification and detection circuit 230 may refrain from transmitting the error code to the bit flipping circuit 235, thereby preventing the bit flipping circuit 235 from flipping any bits in the data. The bit modification and detection circuit 230 and the techniques to generate the flag 245-b may be further described herein with reference to FIG. 4.

Accordingly, the uncorrectable error detection circuit 240 (e.g., an XOR gate) may obtain, as inputs, the flag 245-a and the flag 245-b, and output the flag 245-c indicating whether an uncorrectable error (e.g., uncorrected error) has occurred within the data 250 read from the array 205. For example, if the value of the flag 245-a is low (e.g., ‘0’), indicating that the syndrome bits 260-a and the syndrome bits 260-b match, the uncorrectable error detection circuit 240 may drive a value of the flag 245-c low (e.g., ‘0’) and the data 250 may be classified as prime data (e.g., no errors were detected or corrected between the writing of the data 250 and the reading of the data 250). If the value of the flag 245-a is driven high (e.g., ‘1’), indicating at least a single-bit error has occurred in the data 250, and the value of the flag 245-b is driven high, indicating that at least single-bit error has been modified in the data 250, the uncorrectable error detection circuit 240 may drive a value of the flag 245-c low (e.g., ‘0’) and the data may be classified as corrected data (e.g., correctable data).

If the value of the flag 245-a is driven high (e.g., ‘1’), indicating at least a single-bit error has occurred in the data 250, and the value of the flag 245-b is driven low (e.g., ‘0’), indicating that the bits of the data 250 have not been modified, the uncorrectable error detection circuit 240 may drive a value of the flag 245-c high (e.g., ‘1’) indicating that an uncorrectable error (e.g., an uncorrected error) has occurred in the data 250 read from the array 205 as compared to the data 250 written to the array 205. For example, if the syndrome bits 260-a and the syndrome bits 260-b do not match, it may be assumed that the data 250 read from the array 205 is different from the data 250 written to the array (e.g., at least one error has occurred). Additionally, if the bit modification and detection circuit 230 generates an error code part of the second subset of the multiple error codes (e.g., part of the phantom codes), the bit flipping circuit 235 may not modify the data 250 (e.g., not correct data). Accordingly, because errors have been detected in the data 250, but the data 250 is not modified, it may be determined that the data 250 includes an uncorrected error. In such examples, the data 250 may be classified as uncorrected data (e.g., phantom error code). The aforementioned logic of the uncorrectable error detection circuit 240 may be shown in Table 1 below:

TABLE 1
Uncorrectable Error Detection Circuit

| Flag 245-a | Flag 245-b | Flag 245-c | Data Classification |
|---|---|---|---|
| 0 | 0 | 0 | Prime Data |
| 1 | 1 | 0 | Single-bit Error Corrected Data |
| 1 | 0 | 1 | Uncorrectable Bit Error Detected |
| 0 | 1 | 1 | Ignore - occurs in case of XOR fault. |

In such examples, the bit flipping circuit 235 may output the data 250 read from the array 205 to the host system 105. Additionally, if flag 245-c is driven high, indicating an uncorrectable error has been detected in the data 250, the memory system 110 may transmit an alert message to the host system 105 indicating that an uncorrectable error has been detected in the data 250, such that the host system 105 may avoid using such data 250.

In some examples, each of the flags 245 may correspond to a respective operand (e.g., bit or entry) of a mode register, where the memory system 110 may update the respective operands of the mode register according to values of the flags 245 (e.g., voltage levels or bit values). In such examples, the memory system 110 may monitor an operand corresponding to the flag 245-c of the mode register to determine whether to alert the host system 105. For example, in response to the flag 245-c being driven to the high level, the operand of the mode register may be set to a first value (e.g., ‘1’), triggering the memory system 110 to output the alert message indicating that an uncorrectable error was detected in the data 250. The use of flag 245-a, flag 245-b, and flag 245-c may increase the diagnostic coverage of an error control scheme.

FIG. 3 shows an example of a syndrome check circuit 300 that supports uncorrectable error detection in memory systems in accordance with examples as disclosed herein. Aspects of the syndrome check circuit 300 may be implemented by aspects of the system 100 and the error correction circuit 200 as described herein with reference to FIGS. 1 and 2. For example, the syndrome check circuit 300 may be an example of the syndrome check circuit 225, as described herein with reference to FIG. 2. The techniques described herein may enable the syndrome check circuit 300 to determine whether the syndrome bits 260-a and the syndrome bits 260-b match.

For example, the syndrome check circuit 300 may include a set of XOR gates 305, a set of OR gates 315-a, a set of OR gates 315-b, a set of OR gates 315-c, and an OR gate 315-d. In such examples, the syndrome check circuit 300 may receive, from the syndrome generator 220 of FIG. 2, the syndrome bits 260-a and the syndrome bits 260-c, where the syndrome bits 260-a may be generated from data as part of a first error control operation at a first time (e.g., a write operation or processing of data at a first time) and the syndrome bits 260-b may be generated from the data as part of a second error control operation at a second time (e.g., a read operation or second processing of the data at a second time).

The syndrome check circuit 300 may compare the syndrome bits 260-a and the syndrome bits 260-b and output the flag 245-a, where the result of the comparison between the syndrome bits 260-a and the syndrome bits 260-b may be syndrome bits 260-c. The syndrome bits 260-c may be referred to as an error code. To compare the syndrome bits 260, the syndrome check circuit 300 may use a respective XOR gate of the set of XOR gates 305. For example, the S0 bit of the syndrome bits 260-a may be compared with the S0 bit of the syndrome bits 260-b using a first XOR gate of the set of XOR gates 305. Accordingly, if the S0 bit of the syndrome bits 260-a is equal to the S0 bit of the syndrome bits 260-b, the S0 bit of the syndrome bits 260-c may be a zero (e.g., if both S0s equal 0, 0 XORed with 0 equals or if both S0s equal 1, 1 XORed with 1 equals 0). Alternatively, if the S0 bit of the syndrome bits 260-a is different from the S0 bit of the syndrome bits 260-b, the S0 bit of the syndrome bits 260-c may be a one (e.g., if S0 of syndrome bits 260-a equals 0 and S0 of syndrome bits 260-b equals 1, or vice versa, 1 XORed with 0 equals 1).

In response to obtaining the syndrome bits 260-c, each bit of the syndrome bits 260-c may be inputted through the set of OR gates 315-a. In some examples, a parity wrapper 310 may also be inputted through the set of OR gates 315-a, where if a parity of the syndrome bits 260 (e.g., or the parity bits associated with the syndrome bits) are odd, the value of the parity wrapper may be high (e.g., ‘1’) and if a parity of the syndrome bits 260 is even, the value of the parity wrapper may be low (e.g., ‘0’). The outputs of the set of OR gates 315-a may be inputted into the set of OR gates 315-b, where the outputs of the set of OR gates 315-b may be inputted into the set of OR gates 315-c. The outputs of the set of OR gates 315-c may be inputted into the OR gate 315-d. As such, the OR gate 315-d may output the flag 245-a.

As described herein, if the syndrome bits 260-a are equal to the syndrome bits 260-b, then the syndrome bits 260-c may be equal to zero. As such, the flag 245-a may be equal to 0, indicating that no errors are detected in the data and the syndrome bits 260-a and the syndrome bits 260-b match. Alternatively, if any one bit of the syndrome bits 260-a is different from the corresponding bit of the syndrome bits 260-b, the output of the corresponding XOR gate may be equal to one. As such, the flag 245-a may be equal to one, indicating that at least a single-bit error has been detected in the data and that the syndrome bits 260-a and the syndrome bits 260-b do not match.

FIG. 4 shows an example of a bit modification and detection circuit 400 that supports uncorrectable error detection in memory systems in accordance with examples as disclosed herein. Aspects of the bit modification and detection circuit 400 may be implemented by aspects of the system 100 and the error correction circuit 200. For example, the bit modification and detection circuit 400 may be an example of the bit modification and detection circuit 230, as described herein with reference to FIG. 2. The bit modification and detection circuit 400 may include a set of OR gates 410-a, a set of OR gates 410-b, a set of OR gates 410-c, a set of OR gates 410-d, an OR gate 410-e, and an AND gate 415. The techniques described herein may enable the bit modification and detection circuit 400 to determine whether one or more bits of the data are modified by a second error control operation performed on the data.

For example, the bit modification and detection circuit 400 may compare first syndrome bits (e.g., syndrome bits 260-a) with second syndrome bits (e.g., syndrome bits 260-b) to determine whether one or more bits of the data are modified. Accordingly, the output of the comparison between the first and second syndrome bits may be, or trigger, one of multiple error codes 405. In such examples, a first subset of the multiple error codes 405 (e.g., valid error codes) may indicate that at least a single-bit error has occurred in the data (e.g., that indicate one or more bit errors have occurred in the data) and indicate the location of the one or more errors within the data, while a second subset of the error codes (e.g., phantom error codes) may indicate no modification to the data.

As such, in order for the bit modification and detection circuit 400 to output the flag 245-b, indicating whether one or more bits of the data are to be modified, the bit modification and detection circuit 400 may utilize the sets of OR gates 410 to OR each of the first subset of error codes 405 (e.g., each of the valid error codes) together, such that the output of the OR gate 410-e may be equal to one (in odd parity) or zero (in even parity). The output of the OR gate 410-e and a parity wrapper 420 may be the input into the AND gate 415, where the parity wrapper 420 (e.g., odd parity equals a ‘1’ or high value, even parity equals a ‘0’) may eliminate any even (if parity is odd) or odd (if parity is even) multi-bit error aliasing error codes from being counted. As such, the flag 245-b (e.g., output) may be high in response to any error code 405, corresponding to a single-bit error correction, being identified. A parity wrapper may be an example of a technique used to detect and correct errors that occur during data transmission. In some cases, the parity wrapper includes one or more bits that are calculated based on the data bits. The one or more bits may change if the data bits change. Therefore, if the data is altered during transmission or storage (due to noise, interference, etc.), this will be reflected in the parity bits, allowing the error to be detected and corrected. In some cases, a parity wrapper may involve adding extra bits (parity bits) to the data being transmitted or stored, which are used to check the integrity of the data at a later time.

As an illustrative example, the first subset of the error codes 405 may include error code 405-a-0, error code 405-b-0, error code 405-c-0, error code 405-d-0, error code 405-e-0, error code 405-f-0, error code 405-g-0, error code 405-h-0, error code 405-i-0, error code 405-j-0, error code 405-k-0, error code 405-l-0, error code 405-m-0, error code 405-n-0, and error code 405-p-0 through 405-a-15, error code 405-b-15, error code 405-c-15, error code 405-d-15, error code 405-e-15, error code 405-f-15, error code 405-g-15, error code 405-h-15, error code 405-i-15, error code 405-j-15, error code 405-k-15, error code 405-l-15, error code 405-m-15, error code 405-n-15, and error code 405-p-0, where each error code 405-x-y may correspond to a respective DQ pin (x) at a same unit interval (y). In some cases, a unit interval may refer to a time duration taken to transmit a single bit of data. In a single data rate communication system, a unit interval may be equivalent to one clock cycle. In a double data rate communication system, a unit interval may be equivalent to one half of a clock cycle. As such, if the comparison of the first and second syndrome bits generates the error code 405-a-0, the output of the OR gate 410-e may be equal to one (in odd parity) or zero (in even parity). Accordingly, the output of the OR gate 410-e may be input into the AND gate 415 along with the parity wrapper 420, such that the flag 245-b (e.g., output of the AND gate 415) may indicate that one or more bit errors have been corrected in the data.

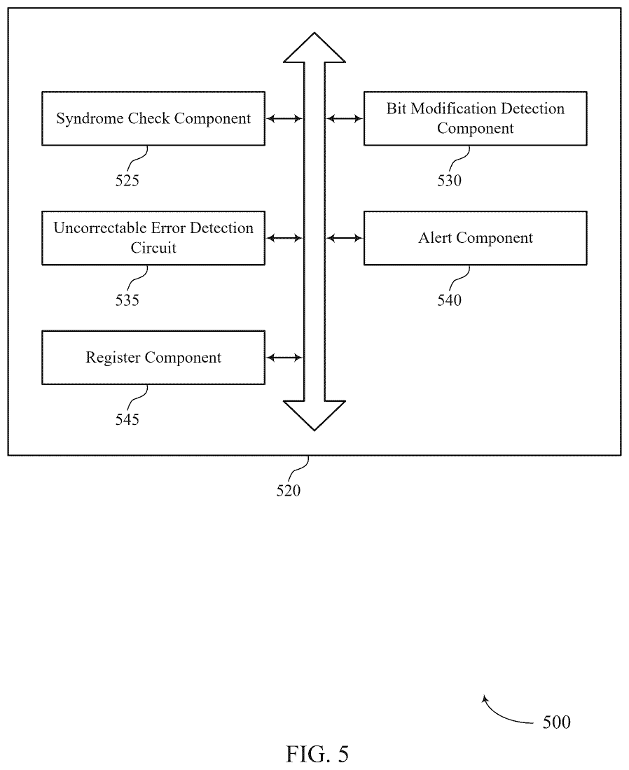

FIG. 5 shows a block diagram 500 of a memory system 520 that supports uncorrectable error detection in memory systems in accordance with examples as disclosed herein. The memory system 520 may be an example of aspects of a memory system as described with reference to FIGS. 1 through 4. The memory system 520, or various components thereof, may be an example of means for performing various aspects of uncorrectable error detection in memory systems as described herein. For example, the memory system 520 may include a syndrome check component 525, a bit modification detection component 530, an uncorrectable error detection circuit 535, an alert component 540, a register component 545, or any combination thereof. Each of these components, or components of subcomponents thereof (e.g., one or more processors, one or more memories), may communicate, directly or indirectly, with one another (e.g., via one or more buses).

The syndrome check component 525 may be configured as or otherwise support a means for performing a syndrome check to compare a first syndrome with a second syndrome, where the first syndrome is generated as part of a first error control operation performed on data at a first time and the second syndrome is generated as part of a second error control operation performed on the data at a second time. In some examples, the syndrome check component 525 may be configured as or otherwise support a means for generating a first flag that indicates whether the first syndrome is equivalent to the second syndrome based at least in part on performing the syndrome check. The bit modification detection component 530 may be configured as or otherwise support a means for generating a second flag that indicates whether the second error control operation resulted in one or more bits of the data being modified. The uncorrectable error detection circuit 535 may be configured as or otherwise support a means for generating a third flag that indicates whether an uncorrectable error is detected in the data during the second error control operation based at least in part on the first flag and the second flag.

In some examples, the third flag indicates that the uncorrectable error was detected during the second error control operation, and the alert component 540 may be configured as or otherwise support a means for transmitting an alert message indicating that the uncorrectable error was detected in the data.

In some examples, the register component 545 may be configured as or otherwise support a means for setting a bit of a register to a first value to indicate that the uncorrectable error was detected in the data based at least in part on generating the third flag, where transmitting the alert message is based at least in part on setting the bit of the register to the first value.

In some examples, the bit modification detection component 530 may be configured as or otherwise support a means for performing a bit modification detection check to determine whether the second error control operation resulted in the one or more bits of the data being modified, where generating the second flag is based at least in part on the determining.

In some examples, the uncorrectable error detection circuit 535 may be configured as or otherwise support a means for performing a multi-bit error check to compare the first flag with the second flag, where generating the third flag is based at least in part on performing the multi-bit error check.

In some examples, the first flag indicates that the first syndrome is equivalent to the second syndrome, the second flag indicates that the one or more bits of the data were not modified during the second error control operation, and the third flag indicates that the uncorrectable error was not detected in the data during the second error control operation based at least in part on the first flag and the second flag.

In some examples, the first flag indicates that the first syndrome is not equivalent to the second syndrome, the second flag indicates that the one or more bits of the data were modified during the second error control operation, and the third flag indicates that the uncorrectable error was not detected in the data during the second error control operation based at least in part on the first flag and the second flag.

In some examples, the first flag indicates that the first syndrome is not equivalent to the second syndrome, the second flag indicates that the one or more bits of the data were not modified during the second error control operation, and the third flag indicates that two errors or more were detected in the data during the second error control operation.

In some examples, the first error control operation and the second error control operation include an on-die error correction code operation.

In some examples, the first error control operation and the second error control operation include a link error correction code operation.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

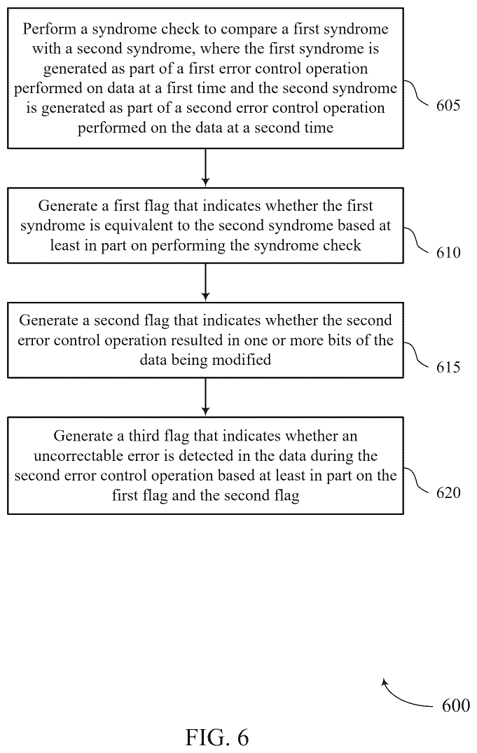

FIG. 6 shows a flowchart illustrating a method 600 that supports uncorrectable error detection in memory systems in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include performing a syndrome check to compare a first syndrome with a second syndrome, where the first syndrome is generated as part of a first error control operation performed on data at a first time and the second syndrome is generated as part of a second error control operation performed on the data at a second time. In some examples, aspects of the operations of 605 may be performed by a syndrome check component 525 as described with reference to FIG. 5.

At 610, the method may include generating a first flag that indicates whether the first syndrome is equivalent to the second syndrome based at least in part on performing the syndrome check. In some examples, aspects of the operations of 610 may be performed by a syndrome check component 525 as described with reference to FIG. 5.

At 615, the method may include generating a second flag that indicates whether the second error control operation resulted in one or more bits of the data being modified. In some examples, aspects of the operations of 615 may be performed by a bit modification detection component 530 as described with reference to FIG. 5.

At 620, the method may include generating a third flag that indicates whether an uncorrectable error is detected in the data during the second error control operation based at least in part on the first flag and the second flag. In some examples, aspects of the operations of 620 may be performed by an uncorrectable error detection circuit 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for performing a syndrome check to compare a first syndrome with a second syndrome, where the first syndrome is generated as part of a first error control operation performed on data at a first time and the second syndrome is generated as part of a second error control operation performed on the data at a second time; generating a first flag that indicates whether the first syndrome is equivalent to the second syndrome based at least in part on performing the syndrome check; generating a second flag that indicates whether the second error control operation resulted in one or more bits of the data being modified; and generating a third flag that indicates whether an uncorrectable error is detected in the data during the second error control operation based at least in part on the first flag and the second flag.
Aspect 2: The method, apparatus, or non-transitory computer-readable medium of aspect 1, where the third flag indicates that the uncorrectable error was detected during the second error control operation and the method, apparatuses, and non-transitory computer-readable medium further includes operations, features, circuitry, logic, means, or instructions, or any combination thereof for transmitting an alert message indicating that the uncorrectable error was detected in the data.
Aspect 3: The method, apparatus, or non-transitory computer-readable medium of aspect 2, further including operations, features, circuitry, logic, means, or instructions, or any combination thereof for setting a bit of a register to a first value to indicate that the uncorrectable error was detected in the data based at least in part on generating the third flag, where transmitting the alert message is based at least in part on setting the bit of the register to the first value.
Aspect 4: The method, apparatus, or non-transitory computer-readable medium of any of aspects 1 through 3, further including operations, features, circuitry, logic, means, or instructions, or any combination thereof for performing a bit modification detection check to determine whether the second error control operation resulted in the one or more bits of the data being modified, where generating the second flag is based at least in part on the determining.
Aspect 5: The method, apparatus, or non-transitory computer-readable medium of any of aspects 1 through 4, further including operations, features, circuitry, logic, means, or instructions, or any combination thereof for performing a multi-bit error check to compare the first flag with the second flag, where generating the third flag is based at least in part on performing the multi-bit error check.
Aspect 6: The method, apparatus, or non-transitory computer-readable medium of any of aspects 1 through 5, where the first flag indicates that the first syndrome is equivalent to the second syndrome, the second flag indicates that the one or more bits of the data were not modified during the second error control operation, and the third flag indicates that the uncorrectable error was not detected in the data during the second error control operation based at least in part on the first flag and the second flag.
Aspect 7: The method, apparatus, or non-transitory computer-readable medium of any of aspects 1 through 6, where the first flag indicates that the first syndrome is not equivalent to the second syndrome, the second flag indicates that the one or more bits of the data were modified during the second error control operation, and the third flag indicates that the uncorrectable error was not detected in the data during the second error control operation based at least in part on the first flag and the second flag.
Aspect 8: The method, apparatus, or non-transitory computer-readable medium of any of aspects 1 through 7, where the first flag indicates that the first syndrome is not equivalent to the second syndrome, the second flag indicates that the one or more bits of the data were not modified during the second error control operation, and the third flag indicates that two errors or more were detected in the data during the second error control operation.
Aspect 9: The method, apparatus, or non-transitory computer-readable medium of any of aspects 1 through 8, where the first error control operation and the second error control operation include an on-die error correction code operation.
Aspect 10: The method, apparatus, or non-transitory computer-readable medium of any of aspects 1 through 9, where the first error control operation and the second error control operation include a link error correction code operation.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 11: A memory system, including: a syndrome check circuit configured to: perform a syndrome check to compare a first syndrome with a second syndrome, where the first syndrome is generated as part of a first error control operation performed on data that occurs at a first time and the second syndrome is generated as part of a second error control operation performed on the data that occurs at a second time; and generate a first flag that indicates whether the first syndrome is equivalent to the second syndrome based at least in part on performing the syndrome check; a bit modification and detection circuit configured to: generate a second flag that indicates whether the second error control operation resulted in one or more bits of the data being modified; and an uncorrectable error detection circuit configured to: generate a third flag that indicates whether an uncorrectable error is detected in the data during the second error control operation based at least in part on the first flag and the second flag.
Aspect 12: The memory system of aspect 11, where the third flag indicates that the uncorrectable error was detected in the data, the memory system further including an alert circuit configured to: output an alert message indicating that the uncorrectable error was detected in the data.
Aspect 13: The memory system of aspect 12, the alert circuit is further configured to: set a bit of a register to a first value indicating that the uncorrectable error was detected in the data based at least in part on the third flag, where outputting the alert message is based at least in part on the bit of the register being set to the first value.
Aspect 14: The memory system of any of aspects 11 through 13, where the syndrome check circuit is further configured to: output the first flag to the uncorrectable error detection circuit based at least in part on generating the first flag.
Aspect 15: The memory system of any of aspects 11 through 14, where the bit modification and detection circuit is further configured to: determine whether the second error control operation resulted in the one or more bits of the data being modified, where generating the second flag is based at least in part on the determining; and output the second flag to the uncorrectable error detection circuit based at least in part on generating the second flag.
Aspect 16: The memory system of any of aspects 11 through 15, where the uncorrectable error detection circuit is configured to: compare the first flag with the second flag, where generating the third flag is based at least in part on comparing the first flag with the second flag.
Aspect 17: The memory system of any of aspects 11 through 16, where the first flag indicates that the first syndrome is equivalent to the second syndrome, the second flag indicates that the one or more bits of the data were not modified during the second error control operation, and the third flag indicates that the uncorrectable error was not detected in the data during the second error control operation based at least in part on the first flag and the second flag.
Aspect 18: The memory system of any of aspects 11 through 17, where the first flag indicates that the first syndrome is not equivalent to the second syndrome, the second flag indicates that the one or more bits of the data were modified during the second error control operation, and the third flag indicates that the uncorrectable error was not detected in the data during the second error control operation based at least in part on the first flag and the second flag.
Aspect 19: The memory system of any of aspects 11 through 18, where the first flag indicates that the first syndrome is not equivalent to the second syndrome, the second flag indicates that the one or more bits of the data were not modified during the second error control operation, and the third flag indicates that two errors or more were detected in the data during the second error control operation.
Aspect 20: The memory system of any of aspects 11 through 18, where the first error control operation and the second error control operation comprise an on-die error correction code operation.
Aspect 21: The memory system of any of aspects 11 through 18, wherein the first error control operation and the second error control operation comprise a link error correction code operation.
Aspect 22: A memory system, including: one or more memory devices; and processing circuitry coupled with the one or more memory devices and configured to cause the memory system to: perform a syndrome check to compare a first syndrome with a second syndrome, where the first syndrome is generated as part of a first error control operation performed on data at a first time and the second syndrome is generated as part of a second error control operation performed on the data at a second time; generate a first flag that indicates whether the first syndrome is equivalent to the second syndrome based at least in part on performing the syndrome check; generate a second flag that indicates whether the second error control operation resulted in one or more bits of the data being modified; and generate a third flag that indicates whether an uncorrectable error is detected in the data during the second error control operation based at least in part on the first flag and the second flag.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
performing a syndrome check to compare a first syndrome with a second syndrome, wherein the first syndrome is generated as part of a first error control operation performed on data at a first time and the second syndrome is generated as part of a second error control operation performed on the data at a second time;
generating a first flag that indicates whether the first syndrome is equivalent to the second syndrome based at least in part on performing the syndrome check;
generating a second flag that indicates whether the second error control operation resulted in one or more bits of the data being modified; and
generating a third flag that indicates whether an uncorrectable error is detected in the data during the second error control operation based at least in part on the first flag and the second flag.

2. The method of claim 1, wherein the third flag indicates that the uncorrectable error was detected during the second error control operation, the method further comprising:
transmitting an alert message indicating that the uncorrectable error was detected in the data.

3. The method of claim 2, further comprising:
setting a bit of a register to a first value to indicate that the uncorrectable error was detected in the data based at least in part on generating the third flag, wherein transmitting the alert message is based at least in part on setting the bit of the register to the first value.

4. The method of claim 1, further comprising:
performing a bit modification detection check to determine whether the second error control operation resulted in the one or more bits of the data being modified, wherein generating the second flag is based at least in part on the determining.

5. The method of claim 1, further comprising:
performing an uncorrectable error check to compare the first flag with the second flag, wherein generating the third flag is based at least in part on performing the uncorrectable error check.

6. The method of claim 1, wherein the first flag indicates that the first syndrome is equivalent to the second syndrome, the second flag indicates that the one or more bits of the data were not modified during the second error control operation, and the third flag indicates that the uncorrectable error was not detected in the data during the second error control operation based at least in part on the first flag and the second flag.

7. The method of claim 1, wherein the first flag indicates that the first syndrome is not equivalent to the second syndrome, the second flag indicates that the one or more bits of the data were modified during the second error control operation, and the third flag indicates that the uncorrectable error was not detected in the data during the second error control operation based at least in part on the first flag and the second flag.

8. The method of claim 1, wherein the first flag indicates that the first syndrome is not equivalent to the second syndrome, the second flag indicates that the one or more bits of the data were not modified during the second error control operation, and the third flag indicates that two errors or more were detected in the data during the second error control operation.

9. The method of claim 1, wherein the first error control operation and the second error control operation comprise an on-die error correction code operation.

10. The method of claim 1, wherein the first error control operation and the second error control operation comprise a link error correction code operation.

11. A memory system, comprising:
a syndrome check circuit configured to:
perform a syndrome check to compare a first syndrome with a second syndrome, wherein the first syndrome is generated as part of a first error control operation performed on data that occurs at a first time and the second syndrome is generated as part of a second error control operation performed on the data that occurs at a second time; and
generate a first flag that indicates whether the first syndrome is equivalent to the second syndrome based at least in part on performing the syndrome check;
a bit modification and detection circuit configured to:
generate a second flag that indicates whether the second error control operation resulted in one or more bits of the data being modified; and
an uncorrectable error detection circuit configured to:
generate a third flag that indicates whether an uncorrectable error is detected in the data during the second error control operation based at least in part on the first flag and the second flag.

12. The memory system of claim 11, wherein the third flag indicates that the uncorrectable error was detected in the data, the memory system further comprising an alert circuit configured to:
output an alert message indicating that the uncorrectable error was detected in the data.

13. The memory system of claim 12, the alert circuit is further configured to:
set a bit of a register to a first value indicating that the uncorrectable error was detected in the data based at least in part on the third flag, wherein outputting the alert message is based at least in part on the bit of the register being set to the first value.

14. The memory system of claim 11, wherein the syndrome check circuit is further configured to:
output the first flag to the uncorrectable error detection circuit based at least in part on generating the first flag.

15. The memory system of claim 11, wherein the bit modification and detection circuit is further configured to:
determine whether the second error control operation resulted in the one or more bits of the data being modified, wherein generating the second flag is based at least in part on the determining; and
output the second flag to the uncorrectable error detection circuit based at least in part on generating the second flag.

16. The memory system of claim 11, wherein the uncorrectable error detection circuit is configured to:
compare the first flag with the second flag, wherein generating the third flag is based at least in part on comparing the first flag with the second flag.

17. The memory system of claim 11, wherein the first flag indicates that the first syndrome is equivalent to the second syndrome, the second flag indicates that the one or more bits of the data were not modified during the second error control operation, and the third flag indicates that the uncorrectable error was not detected in the data during the second error control operation based at least in part on the first flag and the second flag.

18. The memory system of claim 11, wherein the first flag indicates that the first syndrome is not equivalent to the second syndrome, the second flag indicates that the one or more bits of the data were modified during the second error control operation, and the third flag indicates that the uncorrectable error was not detected in the data during the second error control operation based at least in part on the first flag and the second flag.

19. The memory system of claim 11, wherein the first flag indicates that the first syndrome is not equivalent to the second syndrome, the second flag indicates that the one or more bits of the data were not modified during the second error control operation, and the third flag indicates that two errors or more were detected in the data during the second error control operation.

20. The memory system of claim 11, wherein the first error control operation and the second error control operation comprise an on-die error correction code operation.

21. The memory system of claim 11, wherein the first error control operation and the second error control operation comprise a link error correction code operation.

22. A memory system, comprising:
one or more memory devices; and
processing circuitry coupled with the one or more memory devices and configured to cause the memory system to:
perform a syndrome check to compare a first syndrome with a second syndrome, wherein the first syndrome is generated as part of a first error control operation performed on data at a first time and the second syndrome is generated as part of a second error control operation performed on the data at a second time;
generate a first flag that indicates whether the first syndrome is equivalent to the second syndrome based at least in part on performing the syndrome check;
generate a second flag that indicates whether the second error control operation resulted in one or more bits of the data being modified; and
generate a third flag that indicates whether an uncorrectable error is detected in the data during the second error control operation based at least in part on the first flag and the second flag.
